(19) United States
(12) Patent Application Publication
(10) Pub. No.: US 2008/0118003 A1
(43) Pub. Date: May 22, 2008

(54) Enhanced Wireless Communication System and Method Thereof

(75) Inventors: Wen-Chung Liu, Kaohsiung (TW); Gin-Kou Ma, Chutung (TW)

Correspondence Address: Akin Gump LLP - Silicon Valley, 3000 El Camino Real, Two Palo Alto Square, Suite 400, Palo Alto, CA, 94306, US

(73) Assignee: INDUSTRIAL TECHNOLOGY RESEARCH INSTITUTE, Chutung Hsinchu (TW)

(21) Appl. No.: 12/023,341

(22) Filed: Jan. 31, 2008

Related U.S. Application Data
(63) Continuation-in-part of application No. 10/618,632, filed on Jul. 15, 2003, now Pat. No. 7,356,093.
(60) Provisional application No. 60/425,733, filed on Nov. 13, 2002.

(51) Int. Cl. H04L 27/20

(52) U.S. Cl. 375/298; 375/295

(57) ABSTRACT

A communication system comprising a channel encoder to generate a binary bit stream, a mapping unit coupled to the channel encoder, the mapping unit configured to receive the binary bit stream from the channel encoder and to map every “n” consecutive bits of the binary bit stream into a symbol in accordance with a mapping table, wherein the symbol has a symbol value related to a modulation mode, “n” being a positive integer, and a number of “m” modulation units coupled to the mapping unit, “m” being a positive integer, the modulation units configured to receive a set of “m” symbols from the mapping unit and modulate the set of “m” symbols based on the modulation mode, wherein a combined value of the symbol values of the set of “m” symbols from the mapping unit is distinguishable from another combined value of the symbol values of another set of “m” symbols from the mapping unit, and wherein a combined value of the symbol values of a set of “m” symbols from the mapping unit corresponds to a distinguishable bit value of the “n” consecutive bits in the binary bit stream.

### CROSS-REFERENCE TO RELATED APPLICATIONS

This application is a continuation-in-part of U.S. patent application Ser. No. 10/618,632, filed Jul. 15, 2003, which claims the benefit of U.S. Provisional Application No. 60/425,733, filed Nov. 13, 2002.

### FIELD OF THE INVENTION

This invention pertains in general to a communication system and, more particularly, to a third-generation wireless communication system.

### BACKGROUND OF THE INVENTION

Modern wireless communication services may be required to provide high-speed data transmission for multimedia applications. For “third-generation” (3G) telecommunication systems, the ability to provide increased system capacity and data rate for individual users are some of the objectives. Generally, in such systems, downlink transmission from a base station to a mobile station may be more significant than uplink transmission because the asymmetric nature of Internet traffic such as web browsing and file transfer protocol (“FTP”) downloads. To enhance data transmission rate and efficiency over wireless channels, coding techniques and multiple transmitter antennas may be employed. For example, to protect information bits from contamination by background noise in a wideband code division multiple access (“WCDMA”) system based on 3rd Generation Partnership Project (“3GPP”), channel coding may be required.

FIG. 1 is a schematic block diagram of an exemplary space-time coding system 10 based on the 3GPP standards. Referring to FIG. 1, the system 10, which may be a frequency division duplex (“FDD”) system, may include a dedicated transport channel (“DTCH”) 12, a channel encoder 14, a rate-matching unit 16 and a space-time lock code (STBC) encoder 18. The DTCH unit 12 may transmit a number of 3,840 information bits coming from upper layers or users in every 10 milliseconds (ms), i.e., 384 kilo bits per second (Kbps). The channel encoder 14, coupled to the DTCH 12, may take the form of a turbo encoder and provide a turbo coding rate of ⅓. Furthermore, the channel encoder 14 may also provide error detection through a cyclic redundancy check (“CRC”) with sixteen (16) padding CRC bits and four (4) tail bits. The turbo code used in the channel encoder 14 may be a parallel-concatenated convolutional code (“PCCC”) with 8-state constituent encoders (not shown) and one turbo code internal interleaver (not shown). The transfer function of the 8-state constituent code for PCCC may be expressed as follows.
G(D)=[1,(1+D+D³)/(1+D¹+D³)]

The transfer function has been described by Gaspa et al., in “Space-Time Coding for UMPT: Performance Evaluation in Combination with Convolutional and Turbo Coding,” Proceedings of the 52.sup.nd IEEE Vehicular Technology Conference, vol. 1, pp. 92-98 (September 2000), and 3GPP Standards: “Multiplexing and Channel Coding (FDD)”, TS 25.212 V5.0.0 (March 2002), and will not be discussed further herein.

Again referring to FIG. 1, the channel encoder 14 may output a coded frame having 11,580 (=(3,480+16+4)×3) bits. The rate-matching unit 16, coupled to the channel encoder 14, may provide a 22% puncturing of the 11,580-bit coded frame, resulting in a net bit number of 9,048 (=11580×(1-22%)) bits.

The STBC encoder 18 may include a space-time block coding unit 182 coupled to the rate-matching unit 16, and a pair of quadrature phase shift keying (“QPSK”) modulation units 184 and 186, which in turn are coupled to the space-time block coding unit 182. The STBC encoder 18 may function to implement transmit diversity.

The system 10 may further include antennas 20 and 22, respectively coupled to the QPSK modulation units 184 and 186. The STBC encoder 18 may provide a coding rate of 1 and, to match up with the QPSK modulation, output a number of 4,524 (=9,048/2) successive QPSK symbols for each of the antennas 20 and 22 in every 10 ms.

FIGS. 2A and 2B are diagrams of a constellation mapping and a signal constellation, respectively, for the coding system 10 shown in FIG. 1. Specifically, FIG. 2A shows a QPSK mapping used in the STBC encoder 18 of the coding system 10 shown in FIG. 1. Referring to FIG. 2A, two successive bits from the rate matching unit 16 may be mapped to form one of a QPSK symbol 0, 1, 2 and 3. FIG. 2B shows the real and imaginary parts of the QPSK signal constellation, in which the QPSK symbols 0, 1, 2 and 3 shown in FIG. 2A correspond to 1, j, −1 and −j in FIG. 2B, respectively.

FIG. 3A shows an equivalent model of the STBC encoder 18 shown in FIG. 1. Referring to FIG. 3A, in the equivalent model, two of four input information bits b₀, b₁, b₂ and b₃ may be mapped into a symbol Q₀, while the other two of the four input information bits b₀, b₁, b₂ and b₃ may be mapped into another symbol Q₁. Furthermore, the symbols Q₀ and −Q₁* may be modulated and then transmitted at an antenna a₁, while the symbols Q₁ and Q₀* may be modulated and then transmitted at another antenna a₂. The basic idea of the STBC encoder 18 has been described, for example, by Alamouti in “A Simple Transmit Diversity Technique for Wireless Communications,” IEEE Journal on Selected Areas in Communications, vol. 16, pp. 1451-1458 (October 1998), and by Tarokh et al., in “Space-Time Block Coding for Wireless Communications: Performance Results,” IEEE Journal on Selected Areas in Communications, vol. 17, pp. 451-460 (March 1999).

A space-time block code may be defined by a p×m transmission matrix Gₘ, where “m” is the number of transmission antennas, and “p” is the number of symbols in a coded block. The entries of the matrix Gm are linear combinations of variables x₁, x₂, . . . , xₖ and their conjugates. For example, for m=2, i.e., two transmitter antennas are used, Gₘ may be represented as:

$${G}_{2} = [ \begin{matrix}{x}_{1} & {x}_{2} \\ - {x}_{2}^{*} & {x}_{1}^{*}\end{matrix} ]$$

where x₁* and x₂* are the complex conjugates of x₁ and x₂, respectively.

In this case, xₖ, for k=1, 2, may be denoted by Qₖ₋₁, which is one of QPSK symbol values. That is, every two successive bits, for example, b₀, b₁, are mapped to a QPSK symbol and then every two successive QPSK symbols, for example, Q₀ and Q₁, form a valid coded block. The signals transmitted from one antenna are Q₀ and −Q₁*, and simultaneously the signals transmitted from the other antenna are Q₁ and Q₀*, where Q₀* and Q₁* are the complex conjugates of Q₀ and Q₁, respectively.

The two QPSK symbols simultaneously transmitted from the two antennas in one QPSK symbol period are air-combined and received by a receiver antenna. The signal constellation for the two air-combined QPSK symbols is shown in FIG. 3B. Referring to FIG. 3B, since each QPSK symbol is mapped to one of the values 1, j, −1 and −j, two combined QPSK symbols result in one of the values 2, 1+j, 2j, −1+j, −2, −1−j, −2j, 1−j and 0, thereby forming a 9-point signal constellation.

The combination of turbo coding and transmit diversity enables the system 10 shown in FIG. 1 to utilize spatial and temporal redundancy to improve transmission efficiency without degrading bit error rate (BER) performance. The system 10 transmits information at 384 Kbps and utilizes successive 4,254 QPSK symbols time. However, since the transmission periods and transmitter characteristics of the system 10 are specified in the 3GPP standards, to increase spectral efficiency through changing modulation schemes may mean to increase system complexity.

### BRIEF SUMMARY OF THE INVENTION

Additional features and advantages of the invention will be set forth in the description which follows, and in part will be apparent from the description, or may be learned by practice of the invention. The objectives and other advantages of the invention will be realized and attained by the systems and methods particularly pointed out in the written description and claims thereof, as well as the appended drawings.

Examples of the present invention may provide a communication system comprising a channel encoder to provide a binary bit stream, a mapping unit coupled to the channel encoder, the mapping unit configured to receive the binary bit stream from the channel encoder and to map every “n” consecutive bits of the binary bit stream into a symbol in accordance with a mapping table, wherein the symbol has a symbol value related to a modulation mode, “n” being a positive integer, and a number of “m” modulation units coupled to the mapping unit, “m” being a positive integer, the modulation units configured to receive a set of “m” symbols from the mapping unit and modulate the set of “m” symbols based on the modulation mode, wherein a combined value of the symbol values of the set of “m” symbols from the mapping unit is distinguishable from another combined value of the symbol values of another set of “m” symbols from the mapping unit, and wherein a combined value of the symbol values of a set of “m” symbols from the mapping unit corresponds to a distinguishable bit value of the “n” consecutive bits in the binary bit stream.

Some examples of the present invention may also provide a communication system comprising an analog-to-digital converter (ADC) to convert analog signals into a digital stream, the digital stream including a number of values, and a mapping unit coupled to the ADC, the mapping unit configured to map each of the values into a number of “n” consecutive bits in a bit stream in accordance with a mapping table, n being a positive integer, wherein each of the values includes a combined value of symbol values, the symbol values being related to a modulation mode, and wherein each of the symbol values corresponds to a symbol into which the “n” consecutive bits are encoded, wherein a first combined value of the symbol values of a first set of “m” symbols is distinguishable from a second combined value of the symbol values of a second set of “m” symbols, “m” being a positive integer, and wherein a combined value of the symbol values of a set of “m” symbols corresponds to a distinguishable bit value of the “n” consecutive bits in the binary bit stream.

Examples of the present invention may further provide a method of enhancing transmission rate in a communication system, the method comprising receiving a binary bit stream, mapping every “n” consecutive bits of the binary bit stream into a symbol in accordance with a mapping table, wherein the symbol has a symbol value related to a modulation mode, “n” being a positive integer, generating a set of “m” symbols, “m” being a positive integer, and modulating the set of “m” symbols based on the modulation mode, wherein a combined value of the symbol values of the set of “m” symbols is distinguishable from another combined value of the symbol values of another set of “m” symbols, and wherein a combined value of the symbol values of a set of “m” symbols corresponds to a distinguishable bit value of the “n” consecutive bits in the binary bit stream.

It is to be understood that both the foregoing general description and the following detailed description are exemplary and explanatory only and are not restrictive of the invention, as claimed.

The accompanying drawings, which are incorporated in and constitute a part of this specification, illustrate one embodiment of the present invention and together with the description, serves to explain the principles of the invention.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a schematic block diagram of an exemplary space-time coding system based on third-Generation Partnership Project (3GPP) standards;

FIGS. 2A and 2B are diagrams of a constellation mapping and a signal constellation, respectively, for the coding system shown in FIG. 1;

FIG. 3A is an equivalent model of a space-time lock code (STBC) encoder shown in FIG. 1;

FIG. 3B shows a signal constellation for air-combined QPSK symbols;

FIG. 4A is a schematic diagram of a virtual constellation mapping (VCM) encoder in accordance with an embodiment of the present invention;

FIG. 4B shows a signal constellation for air-combined QPSK symbols in accordance with an embodiment of the present invention;

FIG. 5 shows a block diagram of a communication system in accordance with an embodiment of the present invention;

FIG. 6A is a schematic diagram of a communication system in accordance with another example of the present invention;

FIG. 6B is a schematic diagram of a communication system in accordance with yet another example of the present invention;

FIGS. 7A and 7B are diagrams showing binary phase shift keying (BPSK) symbols and corresponding mapped values;

FIGS. 8A and 8B are diagrams showing quadrature phase shift keying (QPSK) symbols and corresponding mapped values;

FIGS. 9A and 9B are diagrams showing 8-quadrature amplitude shift keying (8QASK) symbols and corresponding mapped values; and

FIGS. 10A and 10B are diagrams showing 16-quadrature amplitude modulation (16QAM) symbols and corresponding mapped values.

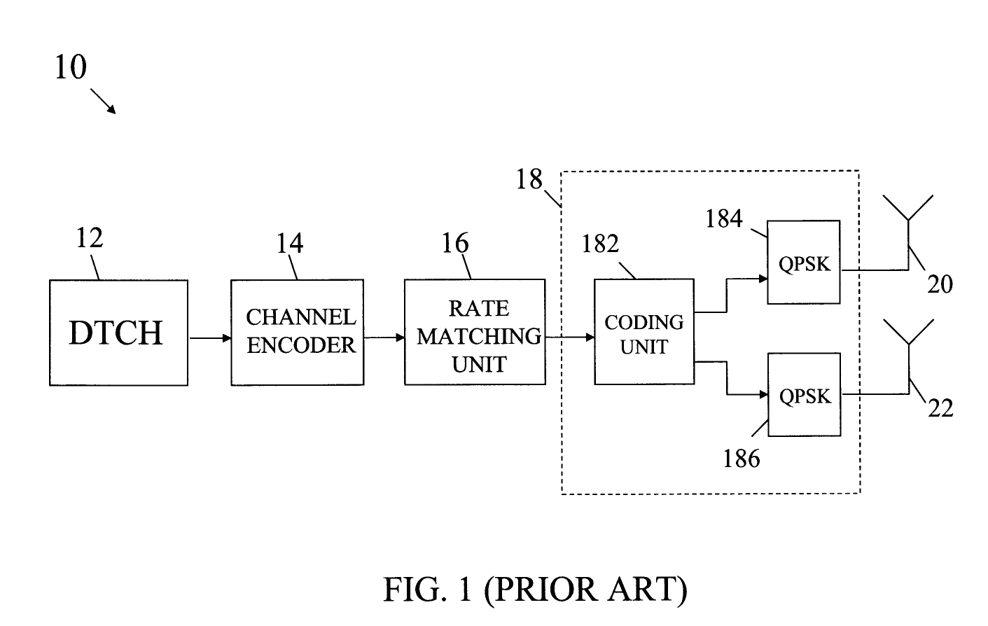

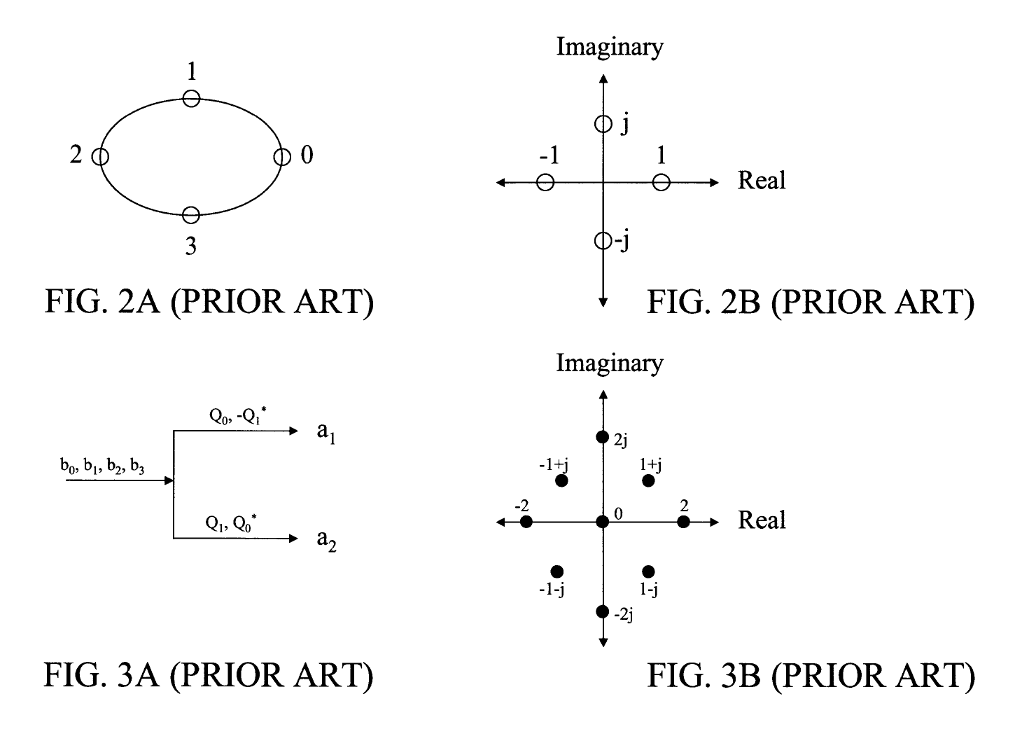

### DETAILED DESCRIPTION OF THE INVENTION

Reference will now be made in detail to exemplary embodiments of the invention, examples of which are illustrated in the accompanying drawings. Wherever possible, the same reference numbers will be used throughout the drawings to refer to the same or like parts.

The present invention provides a communication system and method employing a virtual constellation mapping (“VCM”) encoder. The communication system and method of the present invention may improve data transfer rate without changing any transmission bandwidth, transmitted power or modulation mode in a 3GPP framework.

In a 3GPP framework, as an example of the quadrature phase shift keying (QPSK) modulation, QPSK symbols may be simultaneously transmitted from two transmitter antennas. For an ideal channel condition, a signal “r” received by a receiver antenna may be represented as:
r=C₁+C₂

where C₁ and C₂ are QPSK symbols transmitted from the two transmitter antennas.

However, in a real environment, a received signal “r′” may be a noisy superposition of the two transmitted QPSK symbols corrupted by channel fading. When one receiver antenna is used, the received signal may be represented as:
r′=C₁×h₁+C₂×h₂+noise

where h₁ and h₂ are the path gains from the transmitter antennas to the receiver, and “noise” may refer to the additive white Gaussian noise (“AWGN”).

Since each of the transmitted QPSK symbols C₁ and C₂ includes one of four possible values 1, j, −1 and −j, the received signal r′ may have one of nine possible values, i.e., 2, 1+j, 2j, −1+j, −2, −1−j, −2j, 1−j and 0, as shown in the 9-point signal constellation in FIG. 3B. The QPSK symbols C₁ and C₂ are comprised of four information bits, for example, b₀, b₁, b₂ and b₃, as shown in FIG. 3A. The four information bits that subsequently form the received signal r′ includes a sample space that consists of sixteen 4-bit members.

Conventional STBC encoders only exhibit nine states, or values, in such a sample space in terms of the sum of the two QPSK symbols. Furthermore, conventional STBC decoders require two successive signals to determine the four input information bits. Since a valid STBC coded block is formed within two QPSK symbol lengths, the spectral efficiency of a conventional STBC encoder may be calculated below.
η_{STBC}=4 bits/2 symbol periods/1 Hz=2 (bps/Hz)

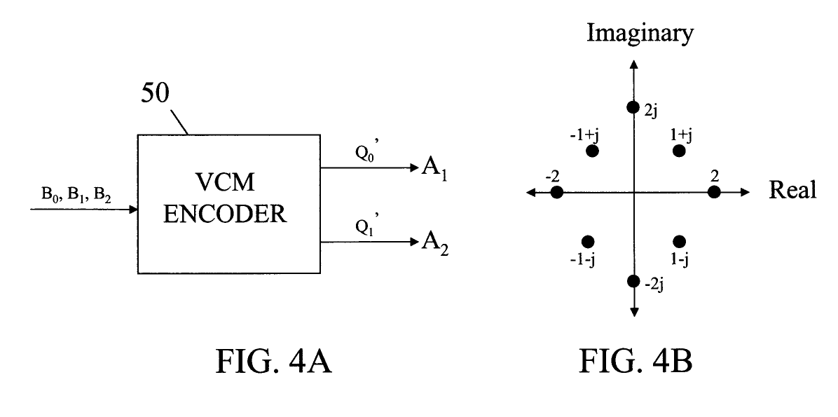

To fully utilize the sixteen 4-bit members of the sample space of the sum of two QPSK symbols, a mapping unit such as a VCM encoder 50 in accordance with an example of the present invention is proposed and shown in FIG. 4A. Referring to FIG. 4A, the VCM encoder 50 may be configured to map a first set of input information bits, for example, B₀, B₁ and B₂, into a first QPSK symbol Q₀′ for a first antenna output A₁ and a second QPSK symbol Q₁′ for a second antenna output A₂ during one symbol period. The QPSK symbols Q₀′ and Q₀′ may be combined in the air and then received by a receiver antenna (not shown). Each of the QPSK symbols Q₀′ and Q₁′ has one of four possible values 0, 1, 2 and 3, which are mapped to real and imaginary parts 1, j, −1 and −j, respectively. Therefore, the air-combined QPSK symbol has one of eight possible values, 2, 1+j, 2j, −1+j, −2, −1−j, −2j, and 1−j, forming an 8-point signal constellation as shown in FIG. 4B. The mapping mechanism for VCM encoder 50 and the air-combined signal states are shown in a lookup table below.

Output QPSK Symbols

| Input | | | |
|---|---|---|---|
| Binary | QPSK Symbols for | QPSK Symbols for | Air-Combined |
| Bits | First Antenna | Second Antenna | Signal States |
| 000 | 0 | 0 | 2 |
| 001 | 0 | 1 | 1 + j |
| 010 | 1 | 2 | −1 + j |
| 011 | 1 | 1 | 2j |
| 100 | 3 | 0 | 1 − j |
| 101 | 3 | 3 | −2j |
| 110 | 2 | 2 | −2 |
| 111 | 2 | 3 | −1 − j |

When every three successive binary bits are fed to the VCM encoder 50, a specific QPSK symbol may be obtained for antenna output. Since the QPSK symbols generated for each antenna are identical, a sample space of the sum of two QPSK symbols consists of eight 3-bit members. Specifically, each member of the sample space corresponds to one of the 3-bit combinations. Therefore, the VCM encoder 50 of the present invention may fully utilize the 3-bit members to achieve encoding efficiency from the view point of air-combined signal constellation. As compared to an STBC encoder that transmits four information bits in two symbol periods, the VCM encoder 50 is able to transmit three bits in one symbol period, six bits in two symbol periods, and so forth. The spectral efficiency of the VCM encoder 50 may be calculated below.
η_{VCM}=6 bits/2 symbol periods/1 Hz=3 (bps/Hz)

Therefore, without changing any modulation scheme, transmission bandwidth or transmitted power, the spectral efficiency of the VCM encoder 50 of the present invention is increased from 2 bps/Hz to 3 bps/Hz, compared to the conventional STBC encoder.

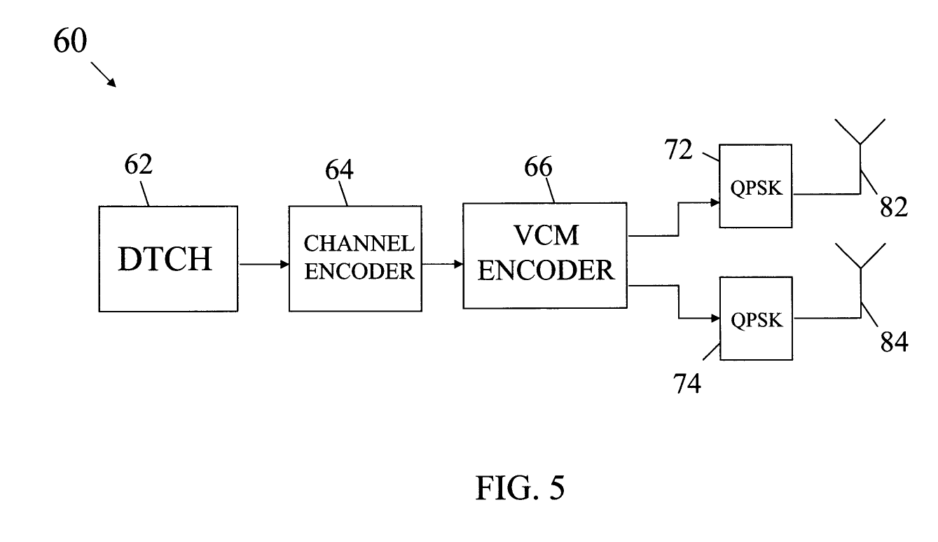

In addition, the VCM encoder 50 may be viewed as a virtual 8-QASK (Quadrature Amplitude Shift Keying) communication system from a receiver's point of view. In one embodiment, the VCM encoder 50 may be applicable to a 3GPP WCDMA communication system shown in FIG. 5. Referring to FIG. 5, a communication system 60 consistent with an embodiment of the present invention may include a dedicated transport channel (“DTCH”) 62, a channel encoder 64 and a VCM encoder 66. In one embodiment, the channel encoder 64, coupled to DTCH 62, may be a ⅓-rate turbo encoder that generates code symbols in a binary bit stream at a rate three times the encoder input. The channel encoder 64 may also provide error detection through a cyclic redundancy check (“CRC”) with sixteen padding CRC bits and 4 tail bits.

The VCM encoder 66 is coupled to the channel encoder 64. In one example, the VCM encoder 66 may be similar to the VCM encoder 50 described and illustrated with reference to FIG. 4A and provide a spectral efficiency of 3 bps/Hz. The communication system 60 may further include a first and a second QPSK modulation units 72 and 74. The first QPSK modulation unit 72 may be coupled between the VCM encoder 66 and a first antenna 82, while the second modulation unit 74 may be coupled between the VCM encoder 66 and a second antenna 84. The first and second modulation units 72 and 74 convert VCM-encoded QPSK symbols to one of four possible values 1, j, −1 and −j. With the VCM encoder 66, the communication system 60 may be able to increase the data rate at DTCH unit 62 from approximately 384 kbps provided by a conventional STBC system to approximately 450.4 kbps.

As a comparison, assuming the conventional STBC system transmits 4,524 QPSK symbols in 10 ms, the system of the present invention may provide the same symbol rate with improved data transfer efficiency. Specifically, the number of information bits in the binary bit stream generated by the channel encoder 64 and communicated to the VCM encoder 66 may be approximately 13,572 (=4,524×3). With a coding rate of ⅓ and 16 padding CRC bits and 4 tail bits, the number of information bits provided from the DTCH channel 62 in every 10 ms to the channel encoder 64 may be approximately 4,504 (13572/3−16−4). That is, the communication system 60 provides a data rate of 450.4 kbps, a 17.3% increase compared to the conventional STBC system. Since system components such as transmission bandwidth, transmitted power and modulation scheme remain the same, the VCM encoder 66 in accordance with the present invention may be implemented in a 3GPP2 environment where multi-carrier modulation is employed, or a wireless local area network (“LAN”) using orthogonal frequency division multiplexing (“OFDM”) modulation.

The above-mentioned examples described and illustrated with reference to FIGS. 4A, 4B and 5 are based on a 3-bit VCM encoding and the QPSK modulation. In other examples according to the present invention, however, a VCM encoder may be configured to encode a binary bit stream by a predetermined number of bit(s) in conjunction with one of a binary phase shift keying (BPSK) modulation, quadrature amplitude shift keying (QASK) modulation and quadrature amplitude modulation (QAM) in addition to the QPSK modulation, as will be discussed below.

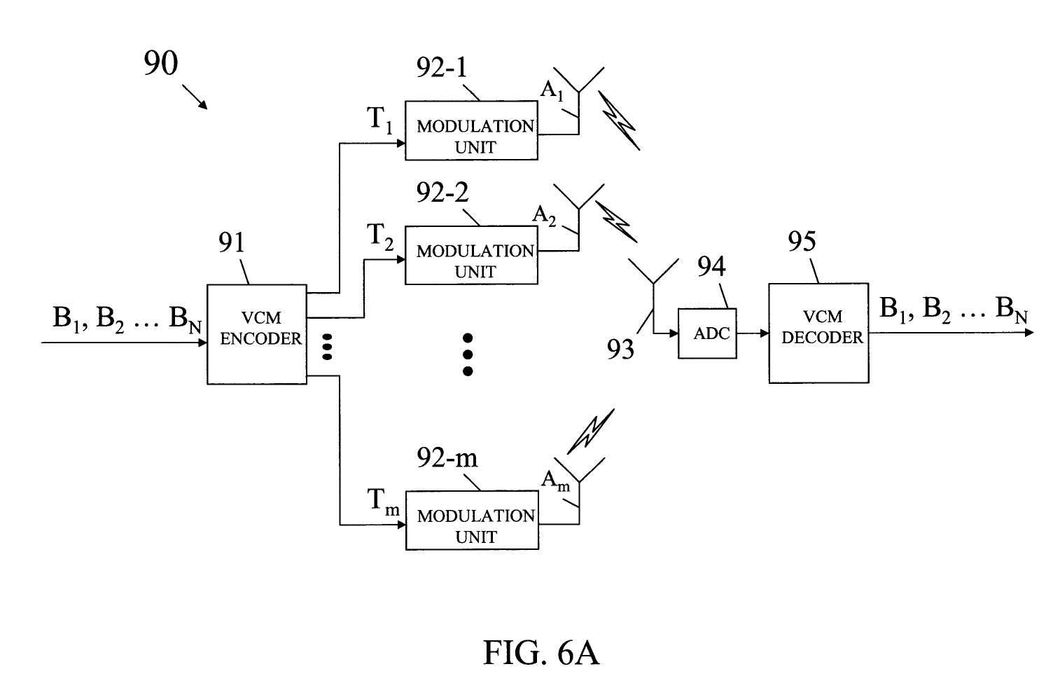

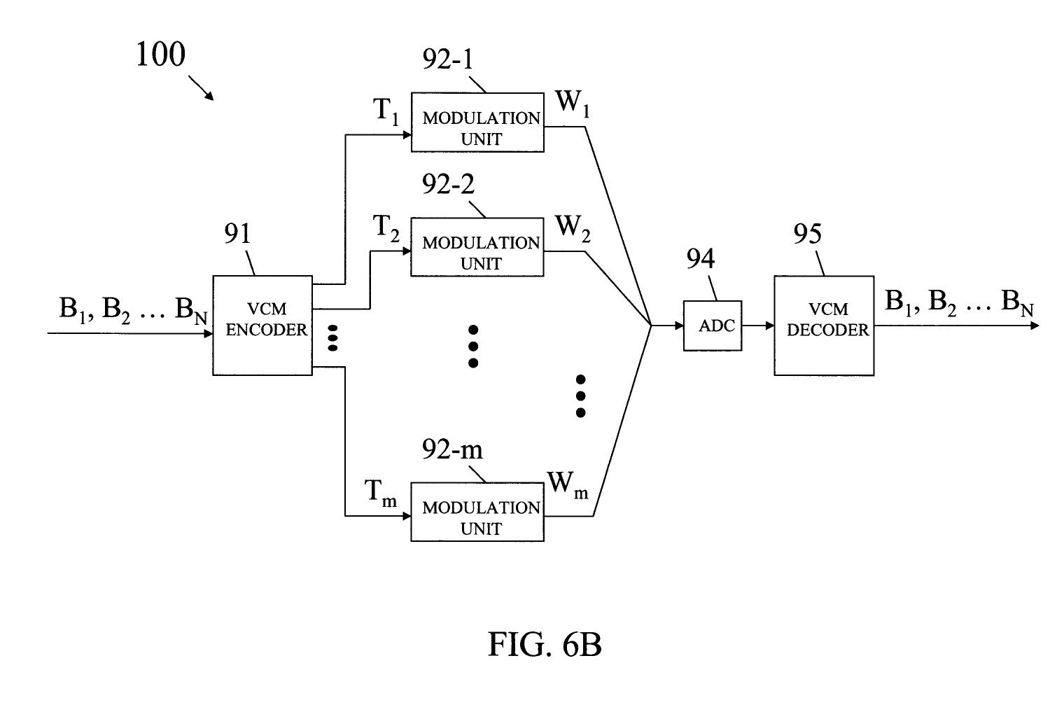

FIG. 6A is a schematic diagram of a communication system 90 in accordance with another example of the present invention. Referring to FIG. 6A, the communication system 90 may include a VCM encoder 91 and a number of “m” modulation units 92-1 to 92-m, m being a positive integer. In one symbol period, the VCM encoder 91 at the transmitter side of the system 90 may receive a set of digital signals in a stream, i.e., a binary bit stream, from a digitized information source (not shown). The binary bit stream B₁ to B_{N}, N being a relatively large positive integer, may contain information bits and channel encoding bits from a channel encoder (not shown). The channel encoder may adopt a low density parity check code (LDPC) scheme, a turbo code scheme, a Hamming code scheme or any other appropriate encoding scheme. Generally, the type of the channel encoder may depend on a desired bit-error rate (BER). In the VCM encoder 91, a set of bits in the binary bit stream B₁ to B_{N} may be mapped into a number of “m” symbols, which in turn may be transmitted through transmission lines T₁ to Tₘ to the modulation units 92-1 to 92-m, respectively. In one example consistent with the present invention, every successive “n” bits of the binary bit stream B₁ to B_{N} may be mapped into a symbol, n being a positive integer, and the number of “m” symbols may form a symbol set. Furthermore, the modulation units 92-1 to 92-m may modulate the symbol set including the number of “m” symbols based on one of the BPSK, QASK, QPSK and QAM modulation.

Modulated signals from the modulation units 92-1 to 92-m may be sent to antennas A₁ to Aₘ, which may in turn transmit the modulated signals via air to at least one receiver antenna 93 at the receiver side of the communication system 90. The signals from the antennas A₁ to Aₘ may be received by the at least one receiver antenna 93 at the receiver side. The received signals may be converted into a stream of combined symbol values at an analog-to-digital converter (ADC) 94. The stream of combined symbol values may be decoded at a VCM decoder 95 into the binary bit stream B₁ to B_{N}.

In one example of the present invention, a desirable modulation scheme may be negotiated between the transmitter and the receiver of the communication system 90 during a synchronization process. Furthermore, the value of “m”, i.e., the number of modulation units for a binary bit stream in a symbol period, may also be determined during the synchronization process. Moreover, a desirable spectral efficiency “η”, and the value of “n”, i.e., the number of successive bits in the binary bit stream to be mapped by the VCM 91 into a symbol, may also be determined in the synchronization process. The values of “m”, “n” and “η” and a modulation type determined for a binary bit stream in a symbol period may not be changed until another symbol period or another synchronization process is required. Table 1 below lists some available transmission modes at different “η”, “n” values and modulation schemes when “m”=1.

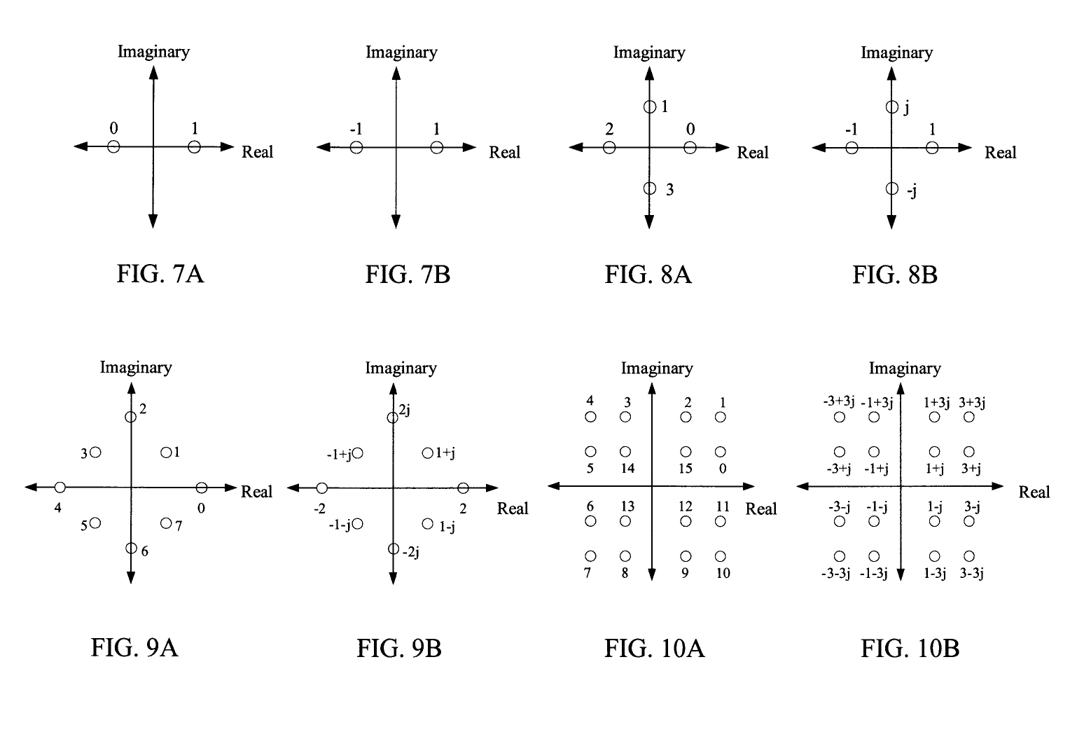

TABLE 1
m = 1

| Spectral | Maximum | | |
|---|---|---|---|
| Efficiency η | Input | | |
| (bps/Hz) | (bits) | Modulation | Symbol & Constellation |
| η = 1 | n = 1 | BPSK | Referring to FIGS. 7A & 7B |
| η = 2 | n = 2 | QPSK | Referring to FIGS. 8A & 8B |
| η = 3 | n = 3 | 8QASK | Referring to FIGS. 9A & 9B |
| η = 4 | n = 4 | 16QAM | Referring to FIGS. 10A & 10B |

Table 1 lists some examples in accordance with the present invention when only one transmission line, for example, the line T₁ and hence the modulation unit 92-1, is used. FIGS. 7A and 7B are diagrams showing binary phase shift keying (BPSK) symbols and corresponding mapped values, respectively. Referring to FIG. 7A, when the spectral efficiency “η” as determined is 1 bps/Hz, only one binary bit may be input and encoded to one of a BPSK symbol and 1 in the VCM encoder 91. The BPSK symbol may then be mapped to one of the values 1 and −1 as shown in FIG. 7B.

FIGS. 8A and 8B are diagrams showing quadrature phase shift keying (QPSK) symbols and corresponding mapped values, respectively. Referring to FIG. 8A, when the spectral efficiency “η” as determined is 2 bps/Hz, two successive binary bits may be input and encoded to one of a QPSK symbol 0, 1, 2 and 3 in the VCM encoder 91. The QPSK symbol may then be mapped to one of the values 1, −1, j and −j as shown in FIG. 8B.

FIGS. 9A and 9B are diagrams showing 8-quadrature amplitude shift keying (8QASK) symbols and corresponding mapped values, respectively. Referring to FIG. 9A, when the spectral efficiency “η” as determined is 3 bps/Hz, three successive binary bits may be input and encoded to one of a 8QASK symbol 0, 1, 2, 3, 4, 5, 6 and 7 in the VCM encoder 91. The 8QASK symbol may then be mapped to one of the values 2, −2, 2j, −2j, 1+j, 1−j, −1+j and −1−j as shown in FIG. 9B.

FIGS. 10A and 10B are diagrams showing 16-quadrature amplitude modulation (16QAM) symbols and corresponding mapped values, respectively. Referring to FIG. 10A, when the spectral efficiency “η” as determined is 4 bps/Hz, four successive binary bits may be input and encoded to one of a 16QAM symbol 0, 1, 2, 3, 4, 5, 6, 7, 8, 9, 10, 11, 12, 13, 14 and 15 in the VCM encoder 91. The 16QAM symbol may then be mapped to one of the values 1+j, 1−j, −1+j, −1−j, 1+3j, 1−3j, −1+3j, −1−3j, 3+3j, 3−3j, −3+3j, −3−3j, 3+j, 3−j, −3+j and −3−j as shown in FIG. 10B.

Referring back to FIG. 6A, in other examples according to the present invention, the communication system 90 may use more than one transmission channels T₁ to Tₘ for data transmission, which means that the number of the transmission lines “m” may be greater than 1. Table 2 below lists some available transmission modes at different “η”, “n” values and modulation schemes when “m”=2.

TABLE 2
m = 2

| Spectral | | | |
|---|---|---|---|
| Efficiency η | Maximum Input | | Input Binary Bits & |
| (bps/Hz) | (bits) | Modulation | Output Symbols |
| η = 3 | n = 3 | QPSK | Referring to Table 2-1 |
| η = 4 | n = 4 | 8QASK | Referring to Table 2-2 |
| η = 6 | n = 6 | 16QAM | Referring to Table 2-3 |

The Tables 2-1, 2-2 and 2-3 in the fourth column of Table 2 show some examples of output symbols when two transmission lines T₁ and T₂ are used.

TABLE 2-1
m = 2, n = 3, QPSK

| Input | Output |
|---|---|
| Binary | Symbols |
| Bits | {T₁, T₂} |
| 000 | 0, 0 |
| 001 | 0, 1 |
| 010 | 1, 2 |
| 011 | 1, 1 |
| 100 | 3, 0 |
| 101 | 3, 3 |
| 110 | 2, 2 |
| 111 | 2, 3 |

TABLE 2-2
m = 2, n = 4, 8QASK

| Input | Output |
|---|---|
| Binary | Symbols |
| Bits | {T₁, T₂} |
| 0000 | 7, 7 |
| 0001 | 4, 2 |
| 0010 | 6, 4 |
| 0011 | 2, 0 |
| 0100 | 2, 1 |
| 0101 | 3, 2 |
| 0110 | 4, 3 |
| 0111 | 1, 0 |
| 1000 | 6, 5 |
| 1001 | 7, 0 |
| 1010 | 7, 6 |
| 1011 | 5, 4 |
| 1100 | 0, 0 |
| 1101 | 2, 2 |
| 1110 | 4, 4 |
| 1111 | 6, 6 |

TABLE 2-3
m = 2, n = 6, 16QAM

| | Output | Input | Output | Input | Output | Input | Output |
|---|---|---|---|---|---|---|---|
| Input | Symbols | Binary | Symbols | Binary | Symbols | Binary | Symbols |
| Binary Bits | {T₁, T₂} | Bits | {T₁, T₂} | Bits | {T₁, T₂} | Bits | {T₁, T₂} |
| 000000 | 2, 6 | 010000 | 14, 3 | 100000 | 0, 11 | 110000 | 2, 4 |
| 000001 | 3, 13 | 010001 | 12, 11 | 100001 | 1, 4 | 110001 | 3, 3 |
| 000010 | 5, 9 | 010010 | 3, 6 | 100010 | 7, 10 | 110010 | 4, 6 |
| 000011 | 5, 15 | 010011 | 15, 0 | 100011 | 4, 7 | 110011 | 5, 5 |
| 000100 | 6, 12 | 010100 | 1, 12 | 100100 | 0, 10 | 110100 | 10, 9 |
| 000101 | 8, 14 | 010101 | 14, 5 | 100101 | 11, 11 | 110101 | 11, 10 |
| 000110 | 13, 13 | 010110 | 5, 8 | 100110 | 8, 10 | 110110 | 5, 4 |
| 000111 | 14, 14 | 010111 | 13, 6 | 100111 | 9, 9 | 110111 | 8, 7 |
| 001000 | 0, 4 | 011000 | 6, 9 | 101000 | 1, 3 | 111000 | 1, 0 |
| 001001 | 0, 12 | 011001 | 8, 11 | 101001 | 2, 2 | 111001 | 2, 1 |
| 001010 | 3, 7 | 011010 | 13, 8 | 101010 | 5, 7 | 111010 | 7, 6 |
| 001011 | 6, 10 | 011011 | 12, 9 | 101011 | 6, 6 | 111011 | 4, 3 |
| 001100 | 0, 3 | 011100 | 14, 4 | 101100 | 7, 9 | 111100 | 10, 10 |
| 001101 | 0, 9 | 011101 | 15, 1 | 101101 | 8, 8 | 111101 | 1, 1 |
| 001110 | 2, 5 | 011110 | 12, 10 | 101110 | 0, 0 | 111110 | 4, 4 |
| 001111 | 15, 2 | 011111 | 13, 7 | 101111 | 1, 11 | 111111 | 7, 7 |

Referring to Table 2-1, every three consecutive bits in the binary bit stream are mapped to a QPSK symbol 0, 1, 2 or 3 shown in FIG. 8A, which may result in a “super constellation” including symbol sets of (0, 0) to (0, 3) and all the way to (3, 0) to (3, 3), or sixteen (=42=4×4) symbol sets in total. In a symbol set (Z₁, Z₂) that may correspond to a constellation point, the symbol “Z₁” may come from the first transmission line T₁, while the symbol “Z₂” may come from the second transmission line T₂ in the transmission mode with m=2, where Z₁, Z₂=0, 1, 2 or 3. Furthermore, each of the symbols Z₁ and Z₂ may have a corresponding value shown in FIG. 8B. However, only a number of 2ⁿ (=8 as n=3 and m=2) constellation points are required and the combined corresponding values of the QPSK symbols “Z₁” and “Z₂” result in nine different values. That is, some of the symbol sets may produce the same combined value. For example, output symbols (0, 1) and (1, 0) may both produce a combined value (1+j), and only one of them (in the present example, (0, 1)) is remained in Table 2-1, while the other (in the present example, (1, 0)) is discarded. Furthermore, a symbol set that produces a combined value of zero may also be discarded. Accordingly, the signal constellation for Table 2-1 includes eight constellation points.

In one example, to determine which symbol set among a number of symbol sets having the same combined value may be remained, an Euclidean distance for each of the symbol sets on a complex plane established by the real axis and the imaginary axis may be calculated. In calculating the Euclidean distance, a symbol set that results in a combined value of zero may be discarded. At the transmitter side, a symbol encoded from a number of “n” consecutive bits may map to one and only one of the constellation points in Table 1 and Table 2 associated with Tables 2-1, 2-2 and 2-3. Likewise, at the receiver side, a received signal corresponding to a constellation point may map to one and only one of the symbols in Table 1 and Table 2 associated with Tables 2-1, 2-2 and 2-3.

Referring to Table 2-2, every four consecutive bits in the binary bit stream are mapped to one of 8-QPSK symbols 0 to 7 shown in FIG. 9A, which may result in a super constellation including symbol sets of (0, 0) to (0, 7) and all the way to (7, 0) to (7, 7), or sixty-four (=8²=8×8 as n=4 and m=2) symbol sets in total. However, only a number of sixteen (2ⁿ=16 as n=4) constellation points are required.

Similarly, referring to Table 2-3, every six consecutive bits in the binary bit stream are mapped to one of 16-QAM symbols 0 to 15 shown in FIG. 10A, which may result in a super constellation including symbol sets of (0, 0) to (0, 15) and all the way to (15, 0) to (15, 15), or two hundred and fifty-six (=16²=16×16 as n=6 and m=2) symbol sets in total. However, only a number of sixty-four (2ⁿ=64 as n=6) constellation points are required.

In some cases the number of different values (Sₜₒₜₐₗ) in a super constellation may be smaller than 2ⁿ, which means that the currently selected modulation scheme may not be able to achieve the desired spectral efficiency. Hence, another modulation scheme may replace the currently selected one so that the value of Sₜₒₜₐₗ may be equal to or greater than 2ⁿ.

Table 3 below lists some available transmission modes at different “i”, “n” values and modulation schemes when “m” is greater than two.

TABLE 3
m = 3 to 7, n = 2 to 9

| Number | Spectral | | |
|---|---|---|---|
| of Transmission | Efficiency η | | |
| Lines | (bps/Hz) | Maximum Input (bits) | Modulation |
| m = 3 | η = 2 | n = 2 | BPSK |
| | η = 4 | n = 4 | QPSK |
| | η = 5 | n = 5 | 8QASK |
| | η = 8 | n = 8 | 16QAM |
| m = 4 | η = 6 | n = 6 | 8QASK |
| | η = 9 | n = 9 | 16QAM |
| m = 5 | η = 5 | n = 5 | QPSK |
| m = 6 | η = 7 | n = 7 | 8QASK |
| m = 7 | η = 3 | n = 3 | BPSK |
| | η = 6 | n = 6 | QPSK |

Referring to Table 3, the value of “m” may range from 3 to 7 while the spectral efficiency may range from 2 to 9, allowing an input binary bit stream being encoded into a symbol every 2 to 9 consecutive bits depending on modulation schemes. In one example, Table 3 as well as Table 1 and Table 2 may be formed in a lookup table (LUT) to facilitate the mapping function in the VCM encoder 91 or the VCM decoder 95. Furthermore, the LUT may be a three-dimensional (3D) table with variables “η”, “n” and “m”. Moreover, the LUT may be stored in a read only memory (ROM) or a random access memory (RAM) in the VCM encoder 91 and the VCM decoder 95. Skilled persons in the art will understand that other LUTs with other “η”, “n” and “m” values and other modulation schemes than those shown in Tables 1, 2 and 3 may be possible.

In one example, an LUT according to the present invention may be established by determining a modulation scheme suitable for a binary stream to be transmitted in one symbol period, and one or more value of “m” for the modulation scheme during a synchronization process. The modulation scheme may include but is not limited to one of the BPSK, QPSK, QASK and QAM. Furthermore, the values of “η” and “n” may also be determined during the synchronization process. When the modulation scheme and “m” are determined, a super constellation may be identified. A signal constellation including a number of 2ⁿ constellation points may be identified by removing unwanted points from the super constellation. A method to remove the unwanted points may include but is not limited to the calculation of Euclidean distance. Each of the constellation points in the signal constellation may match a symbol from the VCM encoder in a one-to-one relationship.

FIG. 6B is a schematic diagram of a communication system 100 in accordance with yet another example of the present invention. The communication system 100 may be similar to the communication system 90 described and illustrated with reference to FIG. 6A except that, for example, conductive wires W₁ to Wₘ replace the antennas A₁ to Aₘ and hence the at least one receiver antenna 93 may be eliminated. Accordingly, the present invention may be implemented in a wireless environment such as the communication system 90, and may be implemented in a wired environment such as the communication system 100.

It will be apparent to those skilled in the art that various modifications and variations can be made in the disclosed process without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

We claim:

1. A communication system comprising:
a channel encoder to generate a binary bit stream;
a mapping unit coupled to the channel encoder, the mapping unit configured to receive the binary bit stream from the channel encoder and to map every “n” consecutive bits of the binary bit stream into a symbol in accordance with a mapping table, wherein the symbol has a symbol value related to a modulation mode, “n” being a positive integer; and
a number of “m” modulation units coupled to the mapping unit, “m” being a positive integer, the modulation units configured to receive a set of “m” symbols from the mapping unit and modulate the set of “m” symbols based on the modulation mode.

2. The system of claim 1, wherein a combined value of the symbol values of the set of “m” symbols from the mapping unit is distinguishable from another combined value of the symbol values of another set of “m” symbols from the mapping unit; and wherein a combined value of the symbol values of a set of “m” symbols from the mapping unit corresponds to a distinguishable bit value of the “n” consecutive bits in the binary bit stream.

3. The system of claim 1, wherein the mapping table includes a signal constellation having a number of “2ⁿ” constellation points, each of the constellation points corresponds to a distinguishable combined value of the symbol values of a set of “m” symbols.

4. The system of claim 1, wherein the mapping table includes a lookup table comprising variables selected from at least one of the values of “n”, “m” and a spectral efficiency and the modulation mode.

5. The system of claim 1, wherein the modulation mode includes one of a binary phase shift keying (BPSK) modulation, quadrature phase shift keying (QPSK) modulation, quadrature amplitude shift keying (QASK) modulation and quadrature amplitude modulation (QAM).

6. The system of claim 1 further comprising a number of “m” antennas coupled to the number of “m” modulation units.

7. The system of claim 5 further comprising a receiver antenna configured to receive signals from the number of “m” antennas.

8. The system of claim 6 further comprising:
an analog-to-digital converter (ADC) coupled to the receiver antenna, the ADC configured to convert the received signals into a stream of combined values; and
another mapping unit configured to map the stream of combined values into a binary bit stream in accordance with the mapping table.

9. The system of claim 1 further comprising:
an analog-to-digital converter (ADC) configured to receive signals from the number of “m” modulation units through a number of “m” transmission lines, and convert the received signals into a stream of combined values; and
another mapping unit configured to map the stream of combined values into a binary bit stream in accordance with the mapping table.

10. A communication system comprising:
an analog-to-digital converter (ADC) to convert analog signals into a digital stream, the digital stream including a number of values; and
a mapping unit coupled to the ADC, the mapping unit configured to map each of the values into a number of “n” consecutive bits in a bit stream in accordance with a mapping table, n being a positive integer, wherein each of the values includes a combined value of symbol values, the symbol values being related to a modulation mode, and wherein each of the symbol values corresponds to a symbol into which the “n” consecutive bits are encoded.

11. The system of claim 10, wherein a first combined value of the symbol values of a first set of “m” symbols is distinguishable from a second combined value of the symbol values of a second set of “m” symbols, “m” being a positive integer, and wherein a combined value of the symbol values of a set of “m” symbols corresponds to a distinguishable bit value of the “n” consecutive bits in the binary bit stream.

12. The system of claim 10, wherein the mapping table includes a signal constellation having a number of “2ⁿ” constellation points, each of the constellation points corresponds to a distinguishable combined value of the symbol values of a set of “m” symbols.

13. The system of claim 10, wherein the mapping table includes a lookup table comprising variables selected from at least one of the values of “n”, “m” and a spectral efficiency and the modulation mode.

14. The system of claim 10, wherein the modulation mode includes one of a binary phase shift keying (BPSK) modulation, quadrature phase shift keying (QPSK) modulation, quadrature amplitude shift keying (QASK) modulation and quadrature amplitude modulation (QAM).

15. The system of claim 10 further comprising a receiver antenna coupled to the ADC, the receiver antenna configured to provide the analog signals.

16. The system of claim 15, wherein the receiver antenna is configured to receive signals from a number of “m” antennas.

17. The system of claim 16 further comprising:
another mapping unit configured to map every “n” consecutive bits in a binary bit stream into a symbol; and
a number of “m” modulation units coupled between the other mapping unit and the antennas, the modulation units configured to receive a set of “m” symbols from the mapping unit and module the set of “m” symbols based on the modulation mode.

18. The system of claim 10 further comprising:
another mapping unit configured to map every “n” consecutive bits in a binary bit stream into a symbol; and
a number of “m” modulation units coupled between the other mapping unit and the ADC, the modulation units configured to receive a set of “m” symbols from the mapping unit and module the set of “m” symbols based on the modulation mode.

19. A method of enhancing transmission rate in a communication system, the method comprising:
receiving a binary bit stream;
mapping every “n” consecutive bits of the binary bit stream into a symbol in accordance with a mapping table, wherein the symbol has a symbol value related to a modulation mode, “n” being a positive integer;
generating a set of “m” symbols, “m” being a positive integer; and
modulating the set of “m” symbols based on the modulation mode,
wherein a combined value of the symbol values of the set of “m” symbols is distinguishable from another combined value of the symbol values of another set of “m” symbols; and
wherein a combined value of the symbol values of a set of “m” symbols corresponds to a distinguishable bit value of the “n” consecutive bits in the binary bit stream.

20. The method of claim 19, wherein the mapping table includes a signal constellation having a number of “2ⁿ” constellation points, each of the constellation points corresponds to a distinguishable combined value of the symbol values of a set of “m” symbols.

21. The method of claim 19, wherein the mapping table includes a lookup table comprising variables selected from at least one of the values of “n”, “m” and a spectral efficiency and the modulation mode.

22. The method of claim 19 further comprising modulating the set of “m” symbols with one of a binary phase shift keying (BPSK) modulation, quadrature phase shift keying (QPSK) modulation, quadrature amplitude shift keying (QASK) modulation and quadrature amplitude modulation (QAM).
